(19) United States
(12) Patent Application Publication
(10) Pub. No.: US 2014/0285649 A1
(43) Pub. Date: Sep. 25, 2014

(54) IMAGE ACQUISITION APPARATUS THAT STOPS ACQUISITION OF IMAGES

(71) Applicant: CASIO COMPUTER CO., LTD., Tokyo (JP)

(72) Inventor: Kouichi SAITOU, Saitama (JP)

(73) Assignee: CASIO COMPUTER CO., LTD., Tokyo (JP)

(21) Appl. No.: 14/220,073

(22) Filed: Mar. 19, 2014

(30) Foreign Application Priority Data
Mar. 22, 2013 (JP) 2013-061071

(51) Int. Cl. H04N 5/232

(52) U.S. Cl. CPC H04N 5/23219; H04N 5/23238
USPC 348/77

(57) ABSTRACT

An image acquisition apparatus 1 includes: an image acquisition unit 43 that sequentially acquires images consecutively captured by an image capture unit 16; a face detection unit 44 that detects a predetermined subject in the acquired image each time an image is acquired; and an image acquisition stop unit 46 that stops the acquisition of target images for composition when the predetermined subject is detected.

This application is based upon and claims the benefit of priority from the prior Japanese Patent Application No. 2013-061071, filed Mar. 22, 2013, and the entire contents of which are incorporated herein by reference.

### BACKGROUND OF THE INVENTION

1. Field of the Invention

The present invention relates to an image acquisition apparatus, an image acquisition method and a recording medium, all of which stop acquisition of images.

2. Related Art

As conventional technology, Japanese Unexamined Patent Application, Publication No. 2010-141517 discloses technology for automatically terminating acquisition of a moving image when a predetermined period of time has elapsed after initiating the acquisition of the moving image.

### SUMMARY OF THE INVENTION

An aspect of an image acquisition apparatus according to the present invention is an image acquisition apparatus, including:

an acquisition unit that sequentially acquires images consecutively captured by an image capture unit while the image capture unit is moved;

a detection unit that detects a predetermined subject in the images acquired by the acquisition unit; and

a stop unit that stops acquisition of the images by the acquisition unit when a predetermined subject is detected by the detection unit.

Furthermore, an aspect of a method of acquiring images according to the present invention is a method of acquiring images, including:

sequentially acquiring images that are consecutively captured by an image capture unit while the image capture unit is moved;

detecting a predetermined subject in the images acquired in the step of acquiring images; and

stopping the acquiring of the images when a predetermined subject is detected in the step of detecting a subject.

Moreover, an aspect of a non-transitory storage medium according to the present invention is a non-transitory storage medium encoded with a computer-readable program that enables a computer to execute functions as:

an acquisition unit that sequentially acquires images consecutively captured by an image capture unit while the image capture unit is moved;

a detection unit that detects a predetermined subject in the images acquired by the acquisition unit; and

a stop unit that stops acquisition of the images by the acquisition unit when a predetermined subject is detected by the detection unit.

### BRIEF DESCRIPTION OF THE DRAWINGS

FIG. 1 is a block diagram showing a hardware configuration of an image acquisition apparatus according to an embodiment of the present invention;

FIG. 2 is a functional block diagram showing a functional configuration for executing image acquisition stop processing, among the functional configurations of the image acquisition apparatus shown in FIG. 1;

FIG. 3 is a diagram illustrating a face image table;

FIG. 4 a diagram showing an aspect of wide-shot photographing;

FIG. 5 is a flowchart showing a flow of the image acquisition stop processing executed by the image acquisition apparatus shown in FIG. 1 having the functional configuration shown in FIG. 2;

FIG. 6 is a flowchart showing a flow of the image acquisition stop processing executed by the image acquisition apparatus shown in FIG. 1 having the functional configuration shown in FIG. 2 according to a first modification example; and

FIG. 7 is a flowchart showing a flow of the image acquisition stop processing executed by the image acquisition apparatus shown in FIG. 1 having the functional configuration shown in FIG. 2 according to a second modification example.

### DETAILED DESCRIPTION OF THE INVENTION

Embodiments of the present invention are hereinafter described with reference to the drawings.

### Configuration

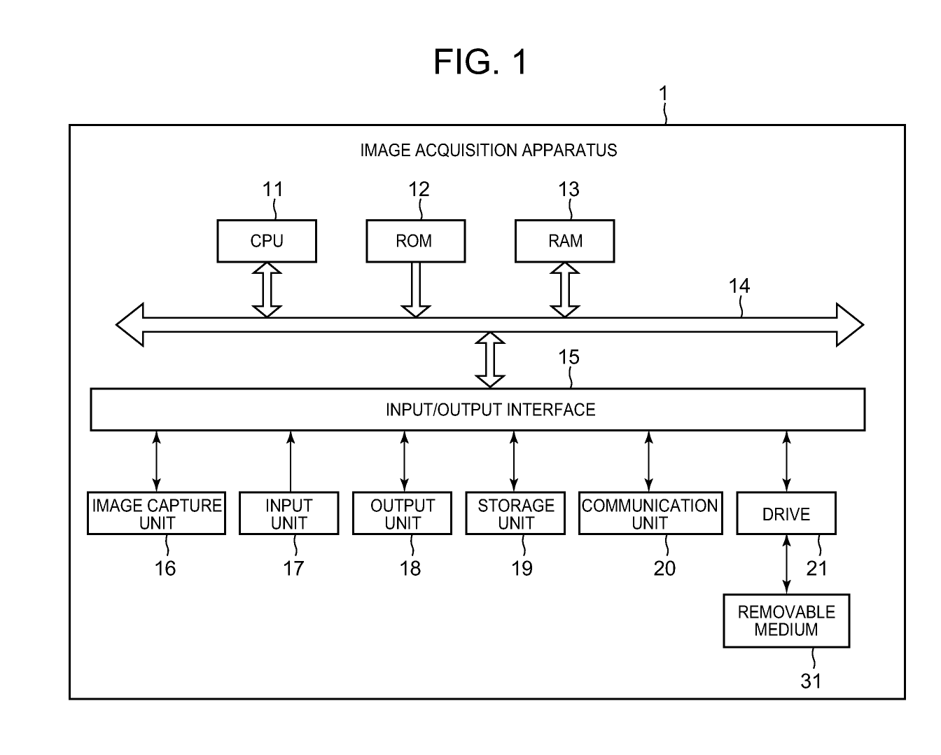

FIG. 1 is a block diagram showing a hardware configuration of an image acquisition apparatus according to an embodiment of the present invention.

An image acquisition apparatus 1 is configured as a digital camera, for example.

The image acquisition apparatus 1 includes a CPU (Central Processing Unit) 11, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20 and the drive 21 are connected to the input/output interface 15.

The image capture unit 16 includes an optical lens unit and an image sensor (not illustrated).

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing on the analog image signal. The variety of signal processing generates a digital signal that is output as an output signal from the image capture unit 16.

Such an output signal of the image capture unit 16 is hereinafter referred to as “image data”. The image data is supplied to the CPU 11, the RAM 13 and the like, as appropriate.

The input unit 17 is configured by various buttons and the like, and inputs various information in accordance with instruction operations of the user.

The output unit 18 is configured by a display, speaker, etc., and outputs images and sound.

The storage unit 19 is configured by a hard disk or DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

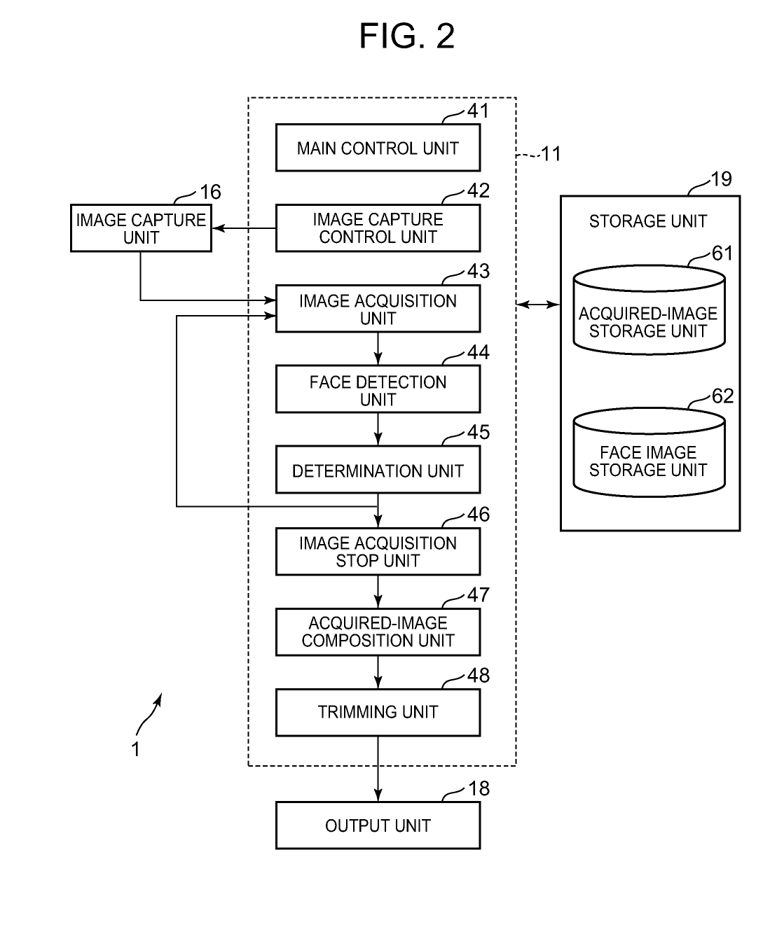

FIG. 2 is a functional block diagram showing a functional configuration for executing image acquisition stop processing, among the functional configurations of such an image acquisition apparatus 1.

In the image acquisition stop processing, the image acquisition apparatus 1 sequentially acquires image data that is consecutively captured, and executes processing for determining presence or absence of a predetermined subject each time the image data is acquired. In the image acquisition stop processing, in a case of determining that the predetermined subject is present, processing for stopping acquisition of image data is executed.

The above sequence of processing is referred to as the image acquisition stop processing.

Examples assumed herein as the consecutively captured images include: continuously captured images in wide-shot photographing; continuously captured images in panoramic photographing; and a plurality of images composing a moving image. In the wide-shot photographing, a wide-angle image is composited from the consecutively captured images by moving a field angle (image capture range) of a digital camera in vertical and horizontal directions. In the panoramic photographing, a wide-angle image is composited from the consecutively captured images by moving the digital camera in a single predetermined direction.

In the present embodiment, in the wide-shot photographing, target images for composition by an acquired-image composition unit 47 (to be described later) are referred to as “target images for composition”. A wide-angle image that is composited from the target images for composition is referred to as a “wide-shot image”. Furthermore, a portion of the wide-shot image remaining after the trimming processing by a trimming unit 48 (to be described later) is referred to as a “trimmed image”.

The wide-shot photographing is described in the present embodiment; however, the present embodiment is not limited thereto, and is also applicable to the panoramic photographing and the moving-image photographing.

As shown in FIG. 2, in a case in which the image acquisition stop processing is executed, a main control unit 41, an image capture control unit 42, an image acquisition unit 43, a face detection unit 44, a determination unit 45, an image acquisition stop unit 46, the acquired-image composition unit 47 and the trimming unit 48 function in the CPU 11.

However, FIG. 2 is an illustrative example, and at least a part of the functions of the CPU 11 may be delegated to hardware such as GA (Graphics Accelerator) for executing image processing.

When the image acquisition stop processing is executed, an acquired-image storage unit 61 and a face image storage unit 62 are used, which are provided as an area of the storage unit 19.

Image data acquired by the image acquisition unit 43 (to be described later) is stored in the acquired-image storage unit 61.

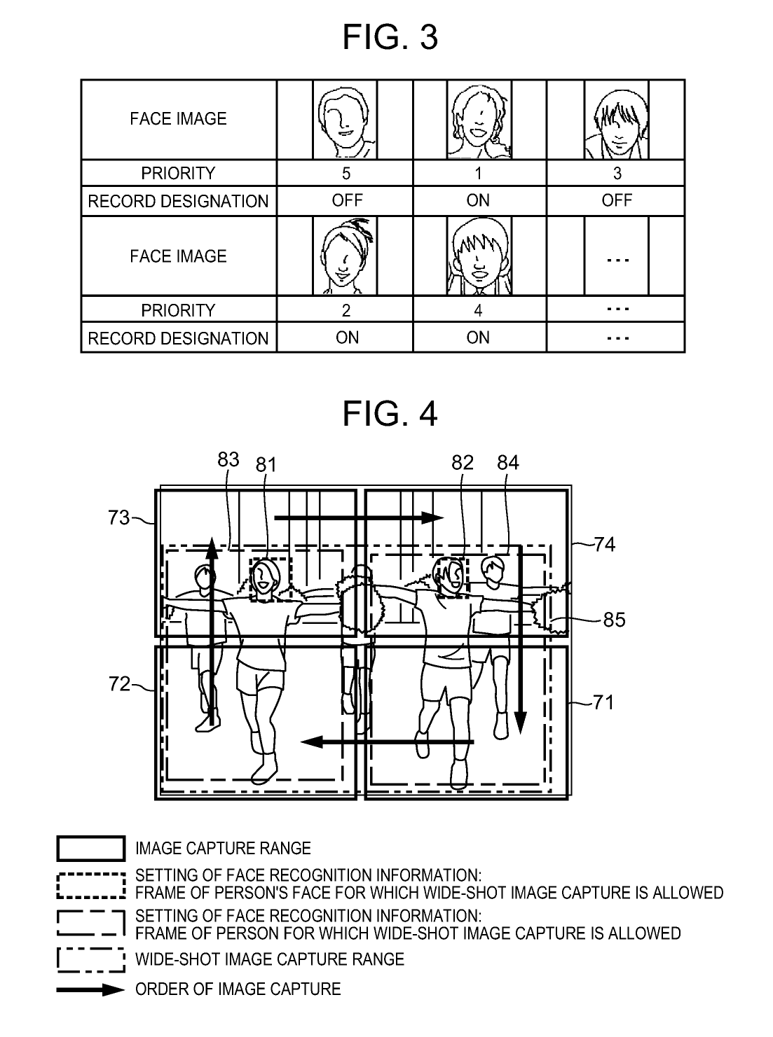

A face image table shown in FIG. 3 is stored in the face image storage unit 62. Priority and record designation are stored in association with each other in the face image table, for each image of a facial portion a person (hereinafter referred to as a “face image”).

When a corresponding face image is detected, the record designation serves as a flag for determining whether an image including the face image is used as a target image for wide-shot composition. The flag of the record designation includes ON and OFF. When at least one face image having the record designation ON is detected in an image, the image including the face image is used as a target image for wide-shot composition. Conversely, even if only face images having the record designation OFF are detected in each image, the images including the face images are not used as target images for wide-shot composition. In the present embodiment, after an instruction is provided to start wide-shot photographing, live-view images are sequentially captured, and at the timing when at least one face image having the record designation ON is detected in a live-view image, target images for wide-shot composition are started to be stored.

Priority is a value representative of a priority order of face images which will be included in trimmed images in a case in which at least two face images are present in a wide-shot image. Regarding the priority order, the priority 1 is the highest, the priority decreases in the order of 2, 3, 4 and 5, and the priority 5 is the lowest. For example, in a case in which a plurality of face images having the record designation ON are detected when capturing target images for composition, processing is executed such as focusing on a face image with the high priority as a main subject.

The main control unit 41 controls the entirety of the image acquisition apparatus 1.

The image capture control unit 42 controls an image capture operation by the image capture unit 16.

More specifically, a user depresses a shutter switch of the input unit 17 while holding the image acquisition apparatus 1 as a digital camera. The image capture control unit 42 then starts consecutive image capture operations of the image capture unit 16, and captures a subject at each predetermined time interval, while the image acquisition apparatus 1 is moved in a predetermined direction.

In particular, as shown in FIG. 4, first of all, the image capture control unit 42 causes the image capture unit 16 to capture an image capture range 71. Subsequently, while maintaining the same range as the image capture range 71, the image capture control unit 42 causes the image capture unit 16 to capture consecutive images at each predetermined time interval, while the image acquisition apparatus 1 is moved in a leftward direction to an image capture range 72. When the image capture unit 16 captures the image capture range 72, while maintaining the same image capture range as the image capture range 72, the image capture control unit 42 causes the image capture unit 16 to capture consecutive images at each predetermined time interval, while the image acquisition apparatus 1 is moved in an upward direction to an image capture range 73. Similarly, when the image capture unit 16 captures the image capture range 73, while maintaining the same image capture range as the image capture range 73, the image capture control unit 42 causes the image capture unit 16 to capture consecutive images at each predetermined time interval, while the image acquisition apparatus 1 is moved in a rightward direction to an image capture range 74. Similarly, when the image capture unit 16 captures the image capture range 74, while maintaining the same image capture range as the image capture range 74, the image capture control unit 42 causes the image capture unit 16 to capture consecutive images at each predetermined time interval, while the image acquisition apparatus 1 is moved in a downward direction to the image capture range 71.

The image capture control unit 42 causes the image capture unit 16 to repeatedly capture the image capture ranges 71 to 74 in this order until a predetermined condition is satisfied.

Each time the image capture unit 16 captures an image, the image capture control unit 42 causes the image capture unit 16 to output image data to the image acquisition unit 43.

With reference to FIG. 2 again, the image acquisition unit 43 acquires image data that is output from the image capture unit 16, and stores the image data into the RAM 13.

The face detection unit 44 detects an image of a facial portion a person (face image) in the image of the image data acquired by the image acquisition unit 43. A face detection device (not shown) is provided; and a face image is detected based on an output from the face detection device.

The determination unit 45 determines whether the face image detected by the face detection unit 44 is registered with the face image table, and whether the face image has the record designation ON. In other words, the determination unit 45 determines whether the image including the detected face image is a target image for wide-shot composition.

When the determination unit 45 determines that the image is a target image for wide-shot composition, the determination unit 45 stores the image data acquired by the image acquisition unit 43 as the first target image for wide-shot composition into the acquired-image storage unit 61. The processing by the image acquisition unit 43 and the face detection unit 44 is further repeated until detecting the face image again. Meanwhile, the determination unit 45 stores the image data acquired by the image acquisition unit 43 into the acquired-image storage unit 61.

The determination unit 45 determines whether the detected face image is detected again. In other words, after the face detection unit 44 detects the face image in the image data, the determination unit 45 determines whether the detected face image is detected again in the image data acquired by the image acquisition unit 43.

In a case in which the determination unit 45 determines that the detected face image is detected again, the determination unit 45 stores the image data acquired by the image acquisition unit 43 as the last target image for wide-shot composition into the acquired-image storage unit 61.

For example, in a case in which the image data of the image capture range 73 including the face image in a frame 81 as shown in FIG. 4 is acquired twice by the image acquisition unit 43, the firstly captured image capture range 73 is stored as the first target image for wide-shot composition into the acquired-image storage unit 61. Image data sequentially acquired after the image of the image capture range 73 is stored into the acquired-image storage unit 61. During the process, images such as an image of the image capture range 74, an image of the image capture range 71, and an image of the image capture range 72 are sequentially stored as target images for wide-shot composition into the acquired-image storage unit 61. Furthermore, the secondly acquired image of the image capture range 73 is stored as the last target image for wide-shot composition into the acquired-image storage unit 61.

When the determination unit 45 stores the image data acquired by the image acquisition unit 43 as the last target image for wide-shot composition into the acquired-image storage unit 61, the image acquisition stop unit 46 stops the acquisition of the image data by the image acquisition unit 43.

The acquired-image composition unit 47 generates a wide-shot image by compositing the first to last target image data for wide-shot composition, which are stored by the determination unit 45 into the acquired-image storage unit 61. More specifically, as shown in FIG. 4, the acquired-image composition unit 47 composites the image data together with images captured therebetween, such that the image in the image capture range 73 is an upper left image, the image in the image capture range 74 is an upper right image, the image in the image capture range 72 is a lower left image, and the image in the image capture range 71 is a lower right image.

The trimming unit 48 generates a trimmed image by trimming the wide-shot image generated by the acquired-image composition unit 47. More specifically, the trimming unit 48 recognizes face images included in the wide-shot image, and determines the frames 81 and 82 representative of image capture regions of the face images shown in FIG. 4. The frames 81 and 82 are determined based on the record designation in the face image table described above. In other words, when the trimmed images are generated, the face images having the record designation ON are determined as the frames 81 and 82. Furthermore, for example, by way of a technique for comparing with a model of a human body shape, the trimming unit 48 determines frames 83 and 84 representative of image capture regions of persons of the recognized face images, based on the frames 81 and 82, respectively. The trimming unit 48 further determines a range 85 of the trimmed image so as to include the frames 83 and 84.

When the range 85 is determined, the trimming unit 48 displays an image of the range 85 as the trimmed image by way of the output unit 18.

### Image Acquisition Stop Processing

Next, descriptions are provided for the image acquisition stop processing executed by the image acquisition apparatus 1.

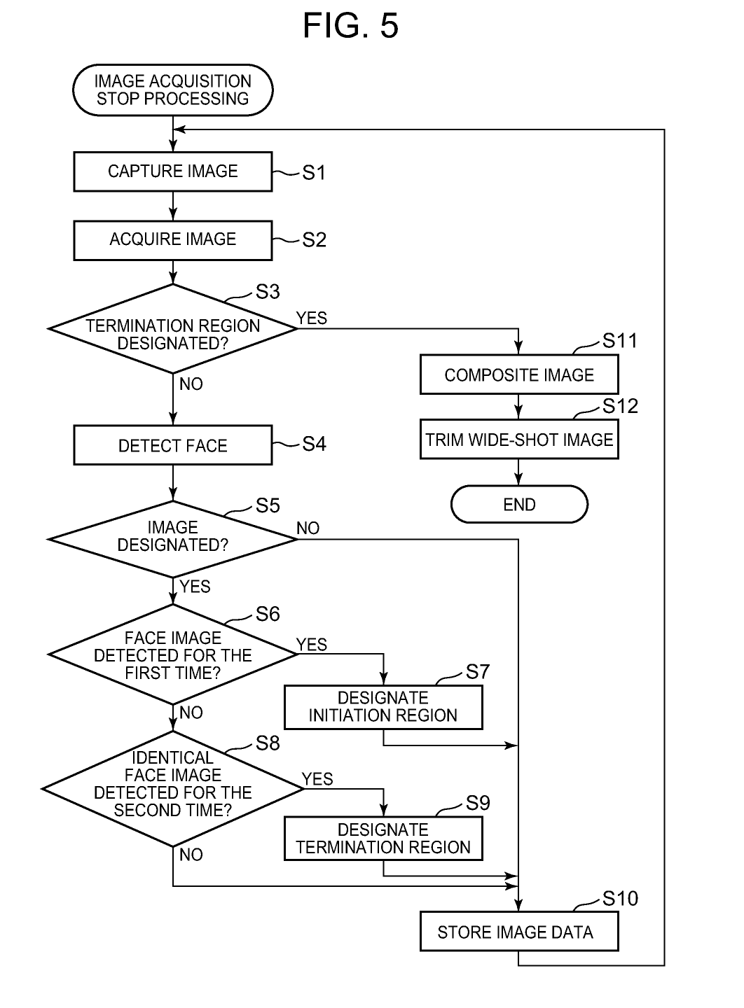

FIG. 5 is a flowchart showing an example flow of the image acquisition stop processing executed by the image acquisition apparatus 1 shown in FIG. 1 having the functional configuration shown in FIG. 2.

In FIG. 5, when the input unit 17 of the image acquisition apparatus 1 is operated to start capturing an image of a subject, the following processing in Steps S1 to S12 is executed.

In Step S1, the image capture control unit 42 controls the image capture operations by the image capture unit 16. More specifically, the user depresses the shutter switch of the input unit 17 while holding the image acquisition apparatus 1 as a digital camera. The image capture control unit 42 then causes the image capture unit 16 to start consecutive image capture operations, and capture an image at each predetermined time interval, while the image acquisition apparatus 1 is moved in a predetermined direction. Furthermore, each time the image capture unit 16 captures an image, the image capture control unit 42 causes the image capture unit 16 to output image data to the image acquisition unit 43.

In Step S2, the image acquisition unit 43 acquires image data that was output from the image capture unit 16 in Step S1, and stores the image data into the RAM 13.

In Step S3, the main control unit 41 determines whether a termination region is designated in Step S9 (to be described later). In a case in which a termination region is not designated, the main control unit 41 advances the processing to Step S4.

In Step S4, the face detection unit 44 detects a face image in the image based on the image data acquired by the image acquisition unit 43.

In Step S5, the determination unit 45 determines whether the face image detected by the face detection unit 44 is registered with the face image table (see FIG. 3), and whether the face image has the record designation ON (such a face image is hereinafter referred to as a “designated face image”). In other words, the determination unit 45 determines whether the image including the detected face image is a target image for wide-shot composition. In a case in which the image is a target image for wide-shot composition, the determination unit 45 advances the processing to Step S6. In a case in which the image is not a target image for wide-shot composition, the determination unit 45 advances the processing to Step S10, and stores the image data acquired in Step S2 into the acquired-image storage unit 61.

In Step S6, the determination unit 45 determines whether the designated face image was detected for the first time. In a case of determining that the designated face image was detected for the first time, the determination unit 45 designates an initiation region in Step S7.

In the image data stored in the acquired-image storage unit 61, the initiation region refers to a region where an image for initiating composition of target images for wide-shot composition is stored.

After the processing in Step S7, the determination unit 45 advances the processing to Step S10, and stores the image data acquired in Step S2 into the acquired-image storage unit 61. In Step S10 following Step S7, the stored image data serves as image data for initiating composition of target images for wide-shot composition.

In a case in which the determination unit 45 determines in Step S6 that the detection of the designated face image was not for the first time, the determination unit 45 determines in Step S8 whether the designated face image was detected for the second time. In a case of determining that the designated face image was detected for the second time, the determination unit 45 designates a termination region in Step S9.

In the image data stored in the acquired-image storage unit 61, the termination region refers to a region where an image for terminating the composition of target images for wide-shot composition is stored.

After the processing in Step S9, the determination unit 45 advances the processing to Step S10, and stores the image data acquired in Step S2 into the acquired-image storage unit 61. In Step S10 following Step S9, the stored image data serves as image data for terminating the composition of target images for wide-shot composition.

In a case in which the determination unit 45 determines in Step S8 that the detection of the designated face image was not for the second time, the determination unit 45 advances the processing to Step S10, and stores the image data acquired in Step S2 into the acquired-image storage unit 61.

When the processing of storing the image data in Step S10 is terminated, the determination unit 45 returns the processing to Step S1.

The processing through Steps S1 to S10 is repeated until determining in Step S3 that a termination region is designated. As a result, all the image data from initiation until termination of the composition of target images is stored into the acquired-image storage unit 61.

In a case of determining in Step S3 that a termination region is designated, the main control unit 41 advances the processing to Step S11.

In Step S11, the acquired-image composition unit 47 generates a wide-shot image by compositing all the image data from the initiation region to the termination region stored in the acquired-image storage unit 61 in Step S10.

In Step S12, the trimming unit 48 generates a trimmed image by trimming the wide-shot image generated by the acquired-image composition unit 47.

The embodiment of the present invention has been described above.

The image acquisition apparatus 1 for executing the image acquisition stop processing as described above includes the image capture unit 16, the image acquisition unit 43, the face detection unit 44, and the image acquisition stop unit 46.

The image capture unit 16 consecutively captures each image capture range as a target image for wide-shot composition.

The image acquisition unit 43 sequentially acquires the captured target images for composition.

Each time a target image for composition is acquired, the face detection unit 44 detects a predetermined subject in the acquired image.

When the predetermined subject is detected, the image acquisition stop unit 46 stops the acquisition of target images for composition.

Therefore, even if the user does not provide any instruction to stop the operation of acquiring target images for composition, the operation of acquiring images can be terminated at a desired point in time.

The image acquisition apparatus 1 further includes the determination unit 45 that determines whether an identical face image was detected at least twice by the face detection unit 44.

In a case in which the determination unit 45 determines that an identical face image was detected at least twice, the image acquisition stop unit 46 stops the acquisition of target images for wide-shot composition.

Therefore, even if the user does not provide any instruction to stop the operation of acquiring target images for wide-shot composition, the operation of acquiring images can be terminated at the timing when an identical face image is detected twice.

The image acquisition apparatus 1 further includes the acquired-image composition unit 47 that generates a wide-shot image from target images for composition sequentially acquired by the image acquisition unit 43.

Therefore, even if the user does not provide any instruction to stop the operation of acquiring target images for composition, the operation of acquiring images can be terminated at a desired point in time, and a wide-shot image can be efficiently generated.

The image acquisition apparatus 1 further includes the determination unit 45 that stores images sequentially acquired by the image acquisition unit 43 as a moving image into the acquired-image storage unit 61.

Therefore, even if the user does not provide any instruction to stop the operation of acquiring images, the operation of acquiring images can be terminated at a desired point in time, and a moving image can be efficiently generated.

The image acquisition apparatus 1 further includes the trimming unit 48 that trims a wide-shot image as the wide-angle image generated by the acquired-image composition unit 47, based on a predetermined subject as a reference.

Therefore, a trimmed image can be generated as a wide-angle image that is suitably composed for a particular subject.

The image capture unit 16 captures a moving image and/or continuously captures images.

Therefore, not only in the wide-shot photographing but also in the moving image photographing and the panoramic photographing, even if the user does not provide any instruction to stop the operation of acquiring images, the operation of acquiring images is terminated at a desired point in time.

The present invention is not limited to the aforementioned embodiment; and modifications, improvements, etc. within a scope that can achieve the object of the present invention are included in the present invention.

### First Modification Example

A first modification example of the present invention is described.

In the first modification example, functional blocks other than the determination unit 45 are identical to those in the above embodiment shown in FIG. 2; therefore, descriptions thereof are omitted. Accordingly, descriptions are provided for only the functions of the determination unit 45.

The determination unit 45 determines whether the face image detected by the face detection unit 44 is registered with the face image table, and whether the face image has the record designation ON. In other words, the determination unit 45 determines whether the image including the detected face image is a target image for wide-shot composition.

When the determination unit 45 determines that the image is a target image for wide-shot composition, the determination unit 45 stores the image data acquired by the image acquisition unit 43 as the first target image for wide-shot composition into the acquired-image storage unit 61. The processing by the image acquisition unit 43 and the face detection unit 44 is further repeated until detecting a particular face image (hereinafter referred to as a “particular designated face image”) which differs from the detected face image. Meanwhile, the determination unit 45 stores the image data acquired by the image acquisition unit 43 into the acquired-image storage unit 61.

The determination unit 45 determines whether a particular designated face image is detected. In other words, the determination unit 45 determines whether the face image detected by the face detection unit 44 coincides with a particular face image stored in the face image table, the particular face image having the corresponding record designation ON.

In a case in which the determination unit 45 determines that the face image detected by the face detection unit 44 coincides with a particular face image, the determination unit 45 stores the image data acquired by the image acquisition unit 43 as the last target image for wide-shot composition into the acquired-image storage unit 61.

Image Acquisition Stop Processing according to First Modification Example

Next, descriptions are provided for the image acquisition stop processing executed by the image acquisition apparatus 1 according to the first modification example.

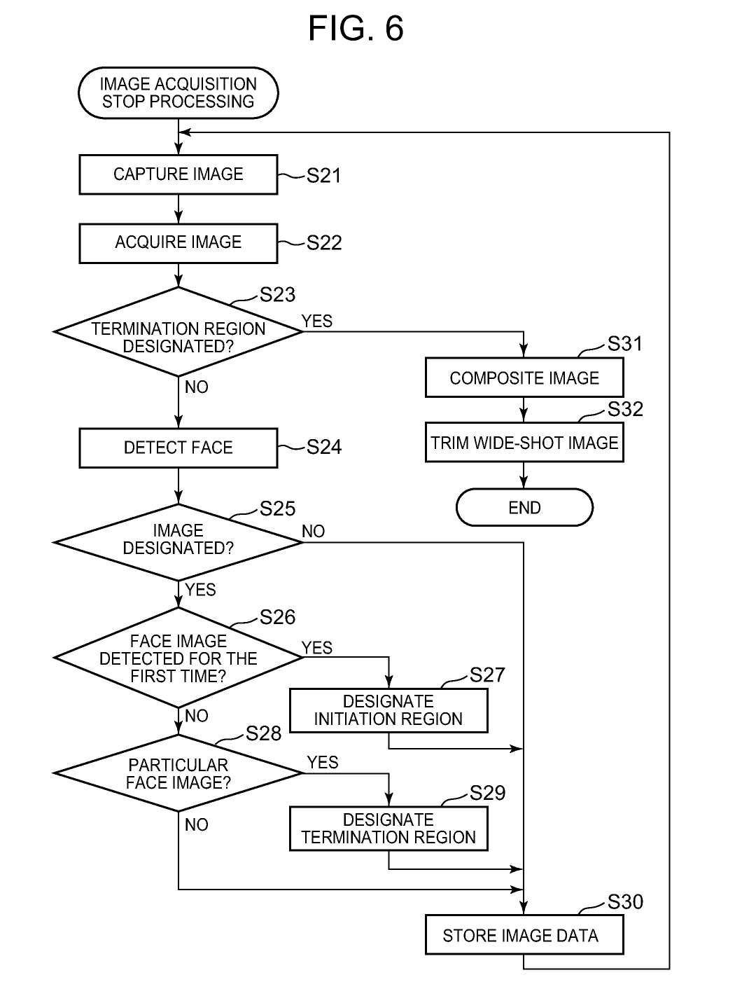

FIG. 6 is a flowchart showing an example flow of the image acquisition stop processing according to the first modification example, which is executed by the image acquisition apparatus 1 shown in FIG. 1 having the functional configuration shown in FIG. 2.

The processing in Steps S21 to S27, S31 and S32 herein is similar to the processing in Steps S1 to S7, S11 and S12 shown in FIG. 5; therefore, descriptions thereof are omitted. Accordingly, descriptions are provided for the processing in Steps S28 to S30.

In a case in which the determination unit 45 determines in Step S26 that the detection of the designated face image was not for the first time, the determination unit 45 determines in Step S28 whether the face image detected by the face detection unit 44 coincides with a particular face image. In a case of determining that the designated face image coincides with the particular face image, the determination unit 45 designates a termination region in Step S29.

After the processing in Step S29, the determination unit 45 advances the processing to Step S30, and stores the image data acquired in Step S22 into the acquired-image storage unit 61. In Step S30 following Step S29, the stored image data serves as image data for terminating the composition of target images for wide-shot composition.

In a case in which the determination unit 45 determines in Step S28 that the face image detected by the face detection unit 44 does not coincide with a particular face image, the determination unit 45 advances the processing to Step S30, and stores the image data acquired in Step S22 into the acquired-image storage unit 61.

When the processing of storing the image data in Step S30 is terminated, the determination unit 45 returns the processing to Step S21.

The processing through Steps S21 to S30 is repeated until determining in Step S23 that a termination region is designated. As a result, all the image data from initiation until termination of the composition of target images for wide-shot composition is stored into the acquired-image storage unit 61.

The first modification example of the present invention has been described above.

The image acquisition apparatus 1 for executing the image acquisition stop processing according to the first modification example includes the image capture unit 16, the image acquisition unit 43, the face detection unit 44, and the image acquisition stop unit 46.

The image capture unit 16 consecutively captures each image capture range as a target image for wide-shot composition.

The image acquisition unit 43 sequentially acquires the captured images.

Each time a target image for composition is acquired, the face detection unit 44 detects a predetermined subject in the acquired image.

In a case in which the predetermined subject is detected, the image acquisition stop unit 46 stops the acquisition of target images for wide-shot composition.

Therefore, even if the user does not provide any instruction to stop the operation of acquiring target images for wide-shot composition, the operation of acquiring images is terminated at a desired point in time.

Target images for composition serve as the basis for composing a wide-shot image.

In a case in which a particular face image is detected, the image acquisition stop unit 46 stops the acquisition of target images for composition.

Therefore, even if the user does not provide any instruction to stop the operation of acquiring target images for composition, the operation of acquiring images is terminated at the timing when a particular face image is detected.

The image capture unit 16 captures a moving image and/or continuously captures images.

Therefore, not only in the wide-shot photographing but also in the moving image photographing and the panoramic photographing, even if the user does not provide any instruction to stop the operation of acquiring images, the operation of acquiring images is terminated at the timing when a particular face image is detected.

### Second Modification Example

A second modification example of the present invention is described.

In the second modification example, functional blocks other than the determination unit 45 are identical to those in the above embodiment shown in FIG. 2; therefore, descriptions thereof are omitted. Accordingly, descriptions are provided for only the functions of the determination unit 45.

The determination unit 45 determines whether the face image detected by the face detection unit 44 is registered with the face image table, and whether the face image has the record designation ON. In other words, the determination unit 45 determines whether the image including the detected face image is a target image for wide-shot composition.

When the determination unit 45 determines that the image is a target image for wide-shot composition, the determination unit 45 stores the image data acquired by the image acquisition unit 43 as the first target image for wide-shot composition into the acquired-image storage unit 61. The processing by the image acquisition unit 43 and the face detection unit 44 is further repeated until detecting face images (designated face images) being registered with the face image table and having the record designation ON are detected for N (N is an integer of at least two) persons (for example, three different persons). Meanwhile, the determination unit 45 stores the image data acquired by the image acquisition unit 43 into the acquired-image storage unit 61.

The determination unit 45 determines whether designated face images for the N persons are detected by the face detection unit 44.

In a case in which the determination unit 45 determines that the designated face images for the N persons are detected, the determination unit 45 stores the image data acquired by the image acquisition unit 43 as the last target image for wide-shot composition into the acquired-image storage unit 61.

Image Acquisition Stop Processing according to Second Modification Example

Next, descriptions are provided for the image acquisition stop processing executed by the image acquisition apparatus 1 according to the second modification example.

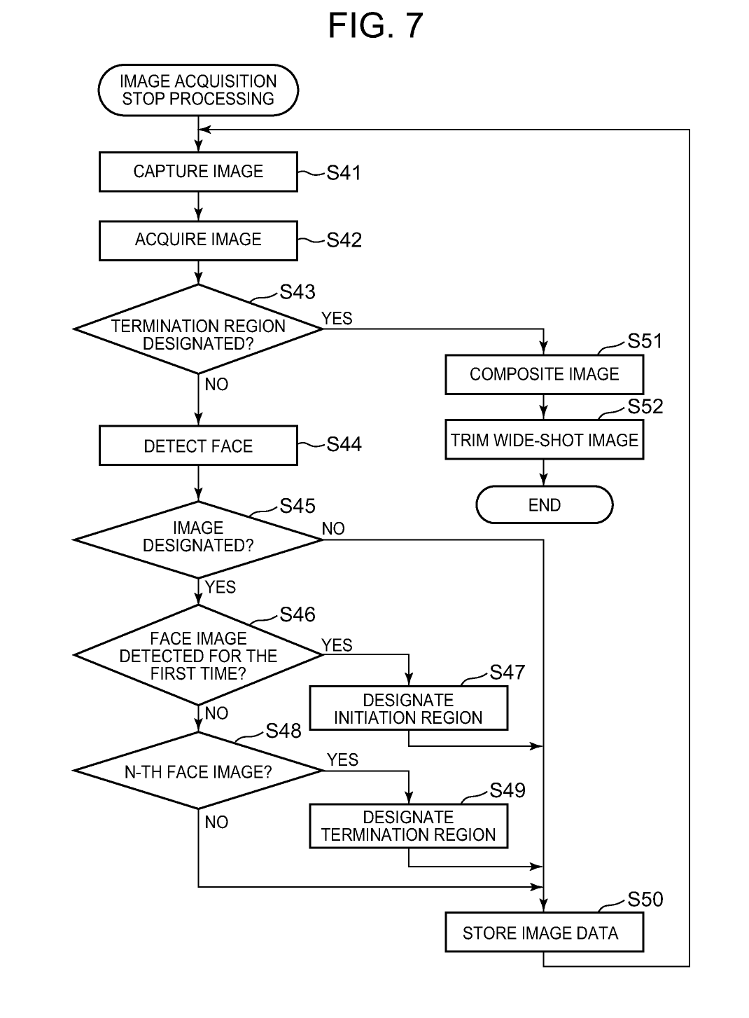

FIG. 7 is a flowchart showing an example flow of the image acquisition stop processing according to the second modification example, which is executed by the image acquisition apparatus 1 shown in FIG. 1 having the functional configuration shown in FIG. 2.

The processing in Steps S41 to S47, S51 and S52 herein is similar to the processing in Steps S1 to S7, S11 and S12 shown in FIG. 5; therefore, descriptions thereof are omitted. Accordingly, descriptions are provided for the processing in Steps S48 to S50.

In a case in which the determination unit 45 determines in Step S46 that the detection of the face image being registered with the face image table and having the record designation ON by the face detection unit 44 was not for the first time, the determination unit 45 determines in Step S48 whether designated face images for N persons are detected by the face detection unit 44. In a case of determining that the designated face images for the N persons are detected, the determination unit 45 designates a termination region in Step S49.

After the processing in Step S49, the determination unit 45 advances the processing to Step S50, and stores the image data acquired in Step S42 into the acquired-image storage unit 61. In Step S50 following Step S49, the stored image data serves as image data for terminating the composition of target images for composition.

In a case in which the determination unit 45 determines in Step S48 that designated face images for N persons are not detected by the face detection unit 44, the determination unit 45 advances the processing to Step S50, and stores the image data acquired in Step S42 into the acquired-image storage unit 61.

When the processing of storing the image data in Step S50 is terminated, the determination unit 45 returns the processing to Step S41.

The processing through Steps S41 to S50 is repeated until determining in Step S43 that a termination region is designated. As a result, all the image data from initiation until termination of the composition of target images for composition is stored into the acquired-image storage unit 61.

The second modification example of the present invention has been described above.

The image acquisition apparatus 1 for executing the image acquisition stop processing according to the second modification example includes the image capture unit 16, the image acquisition unit 43, the face detection unit 44, and the image acquisition stop unit 46.

The image capture unit 16 consecutively captures each image capture range as a target image for wide-shot composition.

The image acquisition unit 43 sequentially acquires the captured images.

Each time a target image for composition is acquired, the face detection unit 44 detects a predetermined subject in the acquired image.

When the predetermined subject is detected, the image acquisition stop unit 46 stops the acquisition of target images for composition.

Therefore, even if the user does not provide any instruction to stop the operation of acquiring target images for composition, the operation of acquiring images is terminated at a desired point in time.

The image acquisition apparatus 1 further includes the determination unit 45 that determines whether the number of face images detected by the face detection unit 44 is at least a predetermined value.

In a case in which the number of face images determined by the determination unit 45 is at least a predetermined value, the image acquisition stop unit 46 stops the acquisition of target images for composition.

Therefore, even if the user does not provide any instruction to stop the operation of acquiring target images for composition, the operation of acquiring images is terminated at the timing when a predetermined number of face images are detected.

The image capture unit 16 captures a moving image and/or continuously captures images.

Therefore, not only in the wide-shot photographing but also in the moving image photographing and the panoramic photographing, even if the user does not provide any instruction to stop the operation of acquiring images, the operation of acquiring images is terminated at the timing when a predetermined number of face images are detected.

In the aforementioned embodiment and the first and second modification examples, a digital camera has been described as an example of the image acquisition apparatus 1 to which the present invention is applied; however, the present invention is not particularly limited thereto.

For example, the present invention can be applied to any electronic device in general having an image processing function. More specifically, for example, the present invention can be applied to a lap-top personal computer, a printer, a television, a video camera, a portable navigation device, a cell phone device, a portable gaming device, and the like.

The processing sequence described above can be executed by hardware, and can also be executed by software.

In other words, the hardware configuration shown in FIG. 2 is merely an illustrative example, and the present invention is not particularly limited thereto. More specifically, the types of functional blocks employed to realize the above-described functions are not particularly limited to the example shown in FIG. 2, so long as the image acquisition apparatus 1 can be provided with the functions enabling the aforementioned processing sequence to be executed in its entirety.

A single functional block may be configured by a single piece of hardware, a single installation of software, or any combination thereof.

In a case in which the processing sequence is executed by software, a program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 shown in FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), or the like. The magnetic optical disk is composed of an MD (Mini-Disk) or the like. The storage medium supplied to the user in a state incorporated in the device main body in advance may include, for example, the ROM 12 shown in FIG. 1, a hard disk included in the storage unit 19 shown in FIG. 1 or the like, in which the program is recorded.

In the present specification, the steps describing the program recorded in the storage medium include not only the processing executed in a time series following this order, but also processing executed in parallel or individually, which is not necessarily executed in a time series.

Although some embodiments of the present invention have been described above, the embodiments are merely illustrative examples, and do not limit the technical scope of the present invention. Various other embodiments can be employed for the present invention, and various modifications such as omission and replacement are possible without departing from the spirit of the present invention. Such embodiments and modifications are included in the scope of the invention and the summary described in the present specification, and are included in the invention recited in the claims as well as the equivalent scope thereof.

What is claimed is:

1. An image acquisition apparatus, comprising:
an acquisition unit that sequentially acquires images consecutively captured by an image capture unit while an image capture range of the image capture unit is moved;
a detection unit that detects a predetermined subject in the images acquired by the acquisition unit; and
a stop unit that stops acquisition of the images by the acquisition unit when the predetermined subject is detected by the detection unit.

2. The image acquisition apparatus according to claim 1, further comprising a first determination unit that determines whether an identical subject is detected at least twice by the detection unit,
wherein the stop unit stops the acquisition of the images by the acquisition unit, when the first determination unit determines that the identical subject is detected at least twice.

3. The image acquisition apparatus according to claim 1, wherein the detection unit detects a plurality of different predetermined subjects,
wherein the apparatus further comprises a second determination unit that determines whether a number of the predetermined subjects is at least a predetermined value, and
wherein the stop unit stops the acquisition of the images by the acquisition unit, when the second determination unit determines that the number of times is at least the predetermined value.

4. The image acquisition apparatus according to claim 1, further comprising a generation unit that generates a wide-angle image from the images sequentially acquired by the acquisition unit.

5. The image acquisition apparatus according to claim 4, further comprising a trimming unit that trims the wide-angle image generated by the generation unit such that the predetermined subject is included in the trimmed wide-angle image.

6. The image acquisition apparatus according to claim 1, further comprising a recording control unit that records the images sequentially acquired by the acquisition unit as a moving image into a recording unit.

7. A method of acquiring images, comprising the steps of:
sequentially acquiring images that are consecutively captured by an image capture unit while an image capture range of the image capture unit is moved;
detecting a predetermined subject in the images acquired in the step of acquiring images; and
stopping the acquiring of the images when a predetermined subject is detected in the step of detecting a subject.

8. A non-transitory storage medium encoded with a computer-readable program that enables a computer to execute functions as:
an acquisition unit that sequentially acquires images consecutively captured by an image capture unit while an image capture range of the image capture unit is moved;
a detection unit that detects a predetermined subject in the images acquired by the acquisition unit; and
a stop unit that stops acquisition of the images by the acquisition unit when a predetermined subject is detected by the detection unit.
